(19) United States
(12) Patent Application Publication
(10) Pub. No.: US 2005/0275118 A1
(43) Pub. Date: Dec. 15, 2005

(54) Fan apparatus with atmosphere treatment function and system thereof

(76) Inventor: Chien-Chin Chen, Pingtung City (TW)

Correspondence Address: John S. Egbert;Harrison & Egbert, 7th Floor, 412 Main Street, Houston, TX, 77002, US

(21) Appl. No.: 10/867,260

(22) Filed: Jun. 14, 2004

(51) Int. Cl. B01F 3/04

(52) U.S. Cl. 261/30; 261/119.1; 261/DIG. 88

(57) ABSTRACT

A fan apparatus for fragrance dissipation, deodorization and sterilization includes a fan and a functional material, where the fan comprises a fan base and at least one blade, and the functional material is a fragrance material or a photocatalyst material. The fan can be driven by a driver whereby the fan can rotate to generate airflow. The functional material is disposed on the fan base or the surface of the blade, or is immersed into the fan. Further, the fan can be molded with the functional material. If the functional material is a photocatalyst material, it is spread on the surface of the fan directly. By virtue of rotating the fan, air can flow through the surface of the fan, thereby the dissipation efficiency of the fragrance material is increased, and the deodorization and sterilization functions of photocatalyst material can be attained.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention is related to a fan apparatus and a system thereof, more specifically to a fan apparatus with atmosphere treatment function and system thereof.

### BACKGROUND OF THE INVENTION

As our living quality progresses, fragrance vaporizers for either natural or artificial perfumes are in wide use in families, offices or cars for removing odor. Because essences serving as the source of fragrance may have the curative effects of sedation, relaxation, reinvigoration and the like, numerous essences and the related apparatuses for air-freshening purposes have become popular in the current market.

Conventionally, volatilizing fragrance materials such as essences can be implemented by heating. Moreover, the fragrance materials can also be immersed into porous woods or ceramics whereby the fragrance can be dissipated spontaneously.

Taiwanese Patent No. 306582 disclosed a fragrance apparatus wherein a fragrance material is disposed on the mesh grill in front of a fan. In addition, the fragrance apparatus dealing with a fragrance material disposed behind a fan has also been seen in the market. The fragrance apparatuses all use the airflow generated by fans to dissipate scents of the fragrance materials. Consequently, the fragrance materials are stationary, so the fragrance dissipations are mainly conducted by spontaneous volatilization of the fragrance materials. Because the amounts of airflows through the fragrance materials are much less than those through the fans, the fragrance materials may not be volatilized effectively by themselves. Thus, ineffective fragrance dissipation might be encountered.

### BRIEF SUMMARY OF THE INVENTION

The objective of the present invention is to provide a fan apparatus with atmosphere treatment function, which uses air flowing through the surface of a fan for atmosphere dissipation efficiency improvement, deodorization or sterilization.

The fan apparatus of the present invention comprises a fan and a functional material, where the fan comprises a fan base and at least one blade. The fan may be driven by a driver whereby the fan can rotate to generate airflow. In addition, the fan can be passively rotated by auxiliary airflow also. The functional material can be an atmosphere material, e.g., a fragrance material, or a photocatalyst material, in which the fragrance material is usually disposed on the surface of the fan base or the blade, or immersed into the fan, and the photocatalyst material is spread on the surface of the fan. Further, the fan can be molded with the functional material directly. By virtue of rotating the fan, a great amount of the airflow generated by the fan can flow through the fan surface spread of the functional material, thereby the dissipation efficiency of the functional material can be increased. If the functional material is photocatalyst, the great amount of the airflow through the photocatalyst material can improve the efficiencies of deodorization and sterilization. Moreover, the fan apparatus can be of an interesting shape so as to be placed at an air outlet for decoration.

The functional material can be attached to or spread on the surface of the fan, or disposed in the fan base having multiple capillaries. The rotation of fan can generate air flowing through the functional material, thereby the dissipation of the functional material can be sped up. If the fan is made of a porous material, it can store the functional material through an immersion or absorption process. A container can be further formed in the fan to store liquid functional material, and the liquid functional material can reach the surface of the fan through the holes included in the porous material by capillary attraction, so as to dissipate the liquid functional material. Before spreading the functional material on the fan, a protection layer can be overlaid first to avoid the chemical reaction of the functional material and the fan. The driver can be a motor or an airflow generator.

If the functional material is photocatalyst, an ultraviolet lamp is employed to illuminate the fan, so as to improve the efficiencies of sterilization and deodorization.

Further, multiple fan apparatuses can be coupled together to obtain various atmospheres, and the fan apparatuses can alternately or simultaneously dissipate various fragrances through a controller, so as to increase the variances of scent and avoid olfaction inactivation.

### BRIEF DESCRIPTION OF THE SEVERAL VIEWS OF THE DRAWINGS

FIG. 1 illustrates the fan apparatus of the first embodiment in accordance with the present invention;

FIG. 2 illustrates the fan apparatus of the second embodiment in accordance with the present invention;

FIG. 3 illustrates the fan apparatus of the third embodiment in accordance with the present invention;

FIG. 4 illustrates the fan apparatus of the fourth embodiment in accordance with the present invention; and

FIG. 5 illustrates the fan system in accordance with the present invention.

### DETAILED DESCRIPTION OF THE INVENTION

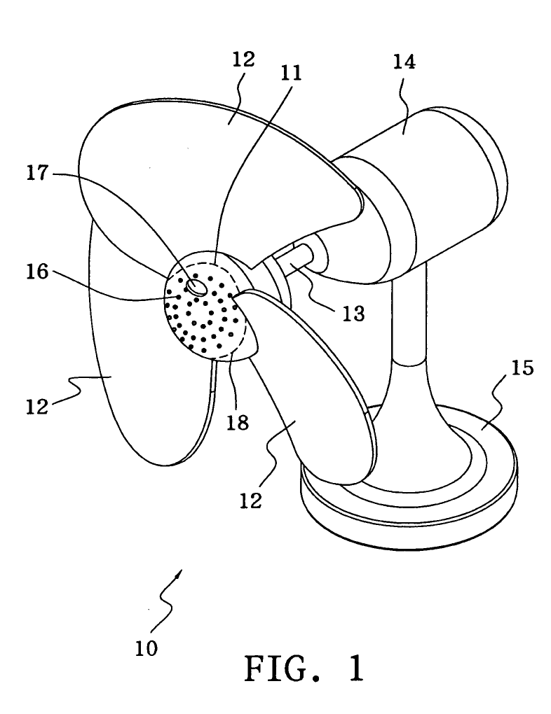

FIG. 1 illustrates the fan apparatus of the first embodiment put forth in the present invention, which is intended to improve the scent of air. A fan apparatus 10 comprises a fan base 11, three blades 12, a rotation shaft 13, a motor 14 and a support 15, where the motor 14 can rotate the fan base 11 and the blades 12 through the shaft 13. The fan base 11 has a container 18 (dashed line) inside for storing a functional material, and an opening 17 for filling the functional material. In addition, the functional material can be disposed on the surface of the fan base 11 also. The fan base 11, i.e., the wall of the container, is provided with multiple capillaries 16 as the fragrance dissipation channels. When the fan base 11 rotates, airflow will go through the surface of the fan base 11, thereby the functional material disposed on or in the fan base 11 can be dissipated more effectively.

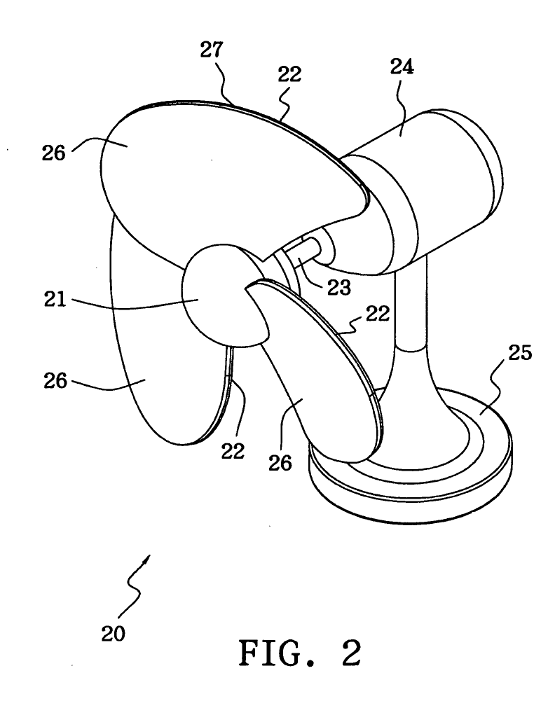

FIG. 2 illustrates the fan apparatus of the second embodiment put forth in the present invention. A fan apparatus 20 comprises a fan base 21, three blades 22, a rotation shaft 23, a motor 24, a support 25 and functional material 26, where the motor 24 rotates the fan base 21 and the blades 22 through the rotation shaft 23. The functional material 26 can be attached to or spread on the surface of the blades 22. Likewise, when the blades 22 rotate, airflow will go through the surface of the blades 22, so that the functional material 26 is dissipated more effectively. The blades 22 can be made of a porous material, e.g., wood, bamboo, ceramic, glass, metal, paper fiber or plastic, thereby the holes in the porous material can store more functional material 26 by an immersion or absorption process. Further, if the functional material 26 includes a substance or solvent that may generate chemical reactions with the blades 22, a protection layer 27 of wood, ceramic, glass, metal, plastic, graphite or the derivatives can be overlaid on the surface of the blades 22 first, so as to avoid chemical reaction.

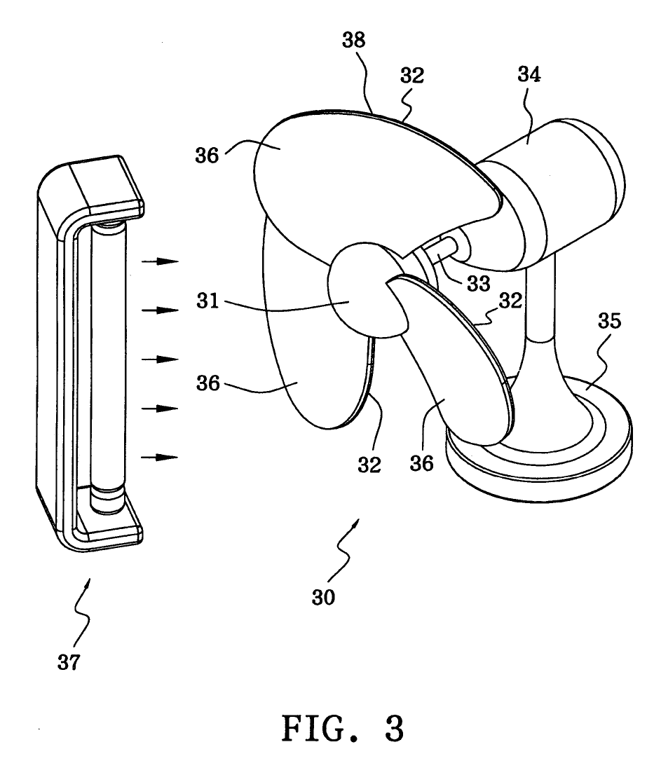

FIG. 3 illustrates the fan apparatus of the third embodiment put forth in the present invention. A fan apparatus 30 comprises a fan base 31, three blades 32, a rotation shaft 33, a motor 34, a support 35, photocatalyst material 36 and an ultraviolet lamp 37, where the motor 34 rotates the fan base 31 and the blades 32 through the shaft 33. The photocatalyst material 36 is attached to or spread on the surface of the blades 32. When the blades 32 rotate, ambient air will vigorously flow through the surface of the blades 32, so that the photocatalyst material 36 is more effective for sterilization and odor removal. The illumination of the ultraviolet lamp 37 on the blades 32 can intensify the effect of the photocatalyst material 36. Moreover, if the photocatalyst material 36 includes a substance or solvent that may generate chemical reactions with the blades 32, a protection layer 38 of ceramic, metal, plastic, graphite or their derivatives can be overlaid on the surface of the blades 32 first, so as to avoid chemical reaction.

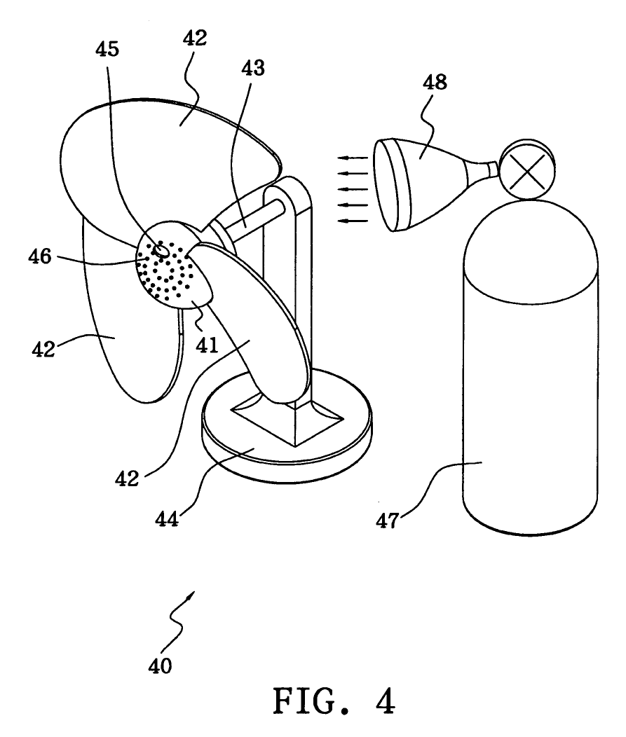

FIG. 4 illustrates the fan apparatus of the fourth embodiment put forth in the present invention. A fan apparatus 40 comprises a fan base 41, three blades 42, a rotation shaft 43, a support 44, a gas bottle 47 and a gas outlet 48, where the fan base 41 and the blades 42 are driven by airflow and rotate with the rotation shaft 43. The airflow is output from the gas bottle 47 through the gas outlet 48. The fan base 41 is provided with an opening 45 for storing functional material inside, and multiple capillaries 46 are formed on the fan base 41 for fragrance dissipation. Besides being generated by the gas bottle 47, airflow can be generated from other airflow generators, e.g., the blower of an air conditioner. For instance, the fan of this embodiment can be installed at the outlet of the air conditioner in a car, so that it is unnecessary to provide with rotation power.

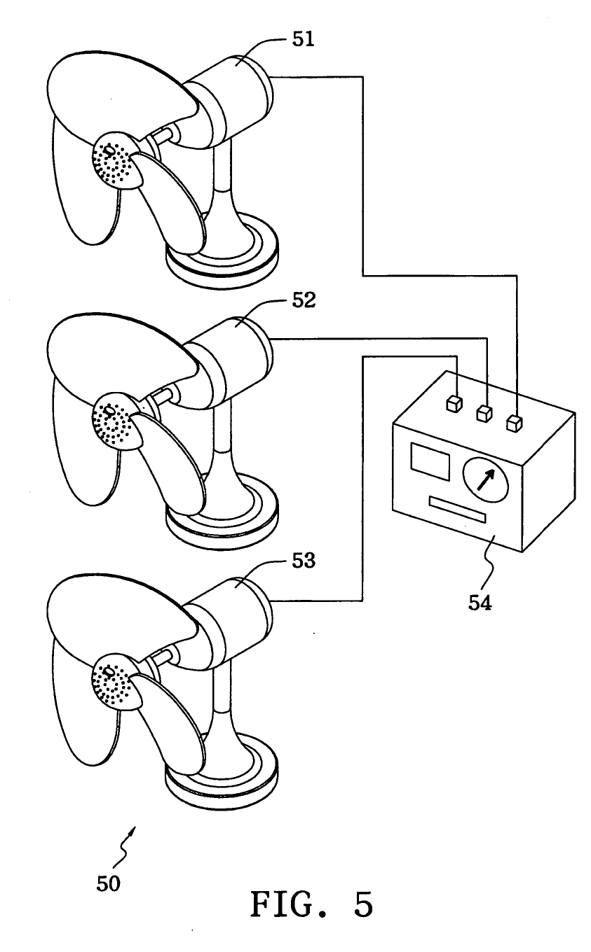

FIG. 5 illustrates a fan system put forth in the present invention. A fan system 50 comprises three fan apparatuses 51, 52, 53 and a controller 54, where the fan apparatuses 51, 52 or 53 can respectively dissipate various fragrances. The controller 54 controls the ON/OFF states and the rotation speeds of the fan apparatuses 51, 52 or 53. By controlling the dissipation timings of the fan apparatuses 51, 52 and 53, mixed scents and variational scents can be obtained so as to retard olfaction inactivation.

The above-described embodiments of the present invention are intended to be illustratively only. Numerous alternative embodiments may be devised by those skilled in the art without departing from the scope of the following claims.

1. A fan apparatus with atmosphere treatment function, comprising:
a fan comprised of a fan base and at least one blade; and
a functional material directly disposed on at least one of the fan base and the blade;
wherein the fan rotates, generating airflow through a surface of the fan to improve the effect of the functional material.

2. The fan apparatus in accordance with claim 1, wherein the fan further comprises a container storing the functional material, a wall of the container being comprised of multiple capillaries as dissipation channels for the functional material.

3. The fan apparatus in accordance with claim 2, wherein the container has an opening for filling the functional material.

4. The fan apparatus in accordance with claim 1, wherein the functional material is a fragrance material.

5. The fan apparatus in accordance with claim 1, wherein the fan is comprised of a porous material.

6. The fan apparatus in accordance with claim 5, wherein the porous material is wood, bamboo, ceramic, glass, metal, paper fiber or plastic.

7. The fan apparatus in accordance with claim 1, wherein the surface of the fan is comprised of a protection layer spread over said surface to avoid chemical reactions of the fan and the functional material.

8. The fan apparatus in accordance with claim 7, wherein the protection layer is comprised of wood, ceramic, glass, metal, plastic, graphite or their deviations.

9. The fan apparatus in accordance with claim 1, further comprising a driver to rotate the fan.

10. The fan apparatus in accordance with claim 9, wherein the driver is a motor.

11. The fan apparatus in accordance with claim 9, wherein the driver is an airflow generator.

12. The fan apparatus in accordance with claim 11, wherein the fan is disposed at the outlet of the airflow generator.

13. The fan apparatus in accordance with claim 1, wherein the fan is molded with the functional material.

14. The fan apparatus in accordance with claim 1, wherein the functional material is a photocatalyst material.

15. The fan apparatus in accordance with claim 14, further comprising an ultraviolet lamp, which can illuminate ultraviolet light on the fan to enhance the effect of the photocatalyst material.

16. A fan system with atmosphere treatment function, comprising:
a plurality of fan apparatuses, each of the fan apparatuses comprising:
a fan being comprised of a fan base and at least one blade;
a driver rotating the fan; and
a functional material directly disposed on at least one of the fan base and the blade; and
a controller controlling the ON/OFF state and rotation speed of the plurality of fan apparatuses.

17. The fan system in accordance with claim 16, wherein the fan is further comprised of a container, and a wall of the container is comprised of multiple capillaries as dissipation channels for the functional material.

18. The fan system in accordance with claim 16, wherein the fan is comprised of a porous material.

19. The fan system in accordance with claim 18, wherein the porous material is wood, bamboo, ceramic, glass, metal, paper fiber or plastic.

20. The fan system in accordance with claim 16, wherein the driver is a motor.
